(19) United States
(12) Patent Application Publication
(10) Pub. No.: US 2016/0247161 A1
(43) Pub. Date: Aug. 25, 2016

(54) SECURE DATA CARDS AND OTHER DEVICES AND APPLICATIONS THEREOF

(71) Applicant: Neem Scientific, Inc., San Diego, CA (US)

(72) Inventors: Deli Wang, San Diego, CA (US); Hongtao Hou, San Diego, CA (US)

(21) Appl. No.: 14/626,273

(22) Filed: Feb. 19, 2015

(51) Int. Cl. G06Q 20/40; G06Q 20/34; G06Q 20/10; G06F 21/31; G06F 21/32

(52) U.S. Cl. CPC G06Q 20/40145; G06F 21/31; G06F 21/32; G06Q 20/105; G06Q 20/341; G06Q 20/4018

(57) ABSTRACT

Disclosed herein are systems of secure data cards and other devices and methods for authorizing secure transactions using the secure data cards or other devices.

### FIELD

Systems and methods disclosed herein relate to secure data cards and other devices and authentication of secure transactions using the secure data cards and other devices.

### BACKGROUND

Data cards are widely used for identification purposes in applications ranging from financial transactions to security and access control. Information stored on the data cards frequently fall victim to abusive and fraudulent activities that have caused significant financial damages to card issuers and cardholders. Over years, card issuers have implemented aggressive measures to combat fraud with limited success. Data card related fraud is still on the rise. According to a recent report, payment card fraud exceeded $11 billion worldwide and $5 Billion in the US in 2012, with certain categories of fraud increasing at a very rapid pace (The Nilson Report, August 2013). Here, payment cards include credit, debit, prepaid general purpose, and private label payment cards.

One of the key measures to combat card fraud is to improve the card authorization requirements for people who want to access the card information.

### SUMMARY

In accordance with one aspect of the subject matter disclosed herein, a method of authorizing a transaction based on a secure data card is provided. In accordance with the method, a passcode is received from a user. The passcode includes a magnitude and/or a temporal duration of pressure applied by the user to a pressure sensor or pressure sensor array disposed on the secure data card. The passcode is compared with an internal passcode associated with the secure data card. The internal passcode is not visibly shown on the secure datacard. The transaction is authorized if the passcode matches the internal passcode or denying the transaction or access if the passcode does not match the internal passcode.

In accordance with another aspect of the subject matter disclosed herein, a method of authorizing a user to access the functionality provided by an electronic device includes receiving a passcode from a user. The passcode includes a magnitude and/or a temporal duration of pressure of a single point of contact applied by the user to a pressure sensor or pressure sensor array disposed on the electronic device. The passcode is compared with an internal passcode associated with the device. The internal passcode is not visibly shown on the electronic device. The user is allowed to access the functionality provided by the electronic device if the passcode matches the internal passcode. Access to the functionality is denied if the passcode does not match the internal passcode.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 shows a schematic block diagram of one example of a secure data card such as a credit card or debit card.

FIG. 2 shows one example of a physical manifestation of a secure data card that may include some or all of the components shown in FIG. 1.

FIGS. 3a-3c are panels of the pressure versus time of a sequence of contact events applied to a pressure sensor or sensor array.

FIGS. 4a-4c are panels of the pressure versus time of another sequence of contact events applied to a pressure sensor or sensor array.

FIGS. 5a-5b are panels of the pressure versus time of yet another sequence of contact events applied to a pressure sensor or sensor array.

FIG. 6 schematically illustrates a cross section of one example of a pressure sensor.

FIG. 7 shows a mobile phone on which one or more pressure sensor or sensor arrays may be disposed.

FIGS. 8a and 8b show the mobile phone of FIG. 7 on which the pressure sensors or sensor arrays are arranged so that they have left-right symmetry when held by a user.

### DETAILED DESCRIPTION

The present invention relates to a data card authentication system that can be implemented with considerations of security, reliability, cost, user experience, and compatibility with current and future data card infrastructure. In one aspect, provided herein is a secure data card for facilitating secure transactions and secure authorization to access a location (e.g., restricted facilities) and/or data (e.g., medical records, websites, or any other information).

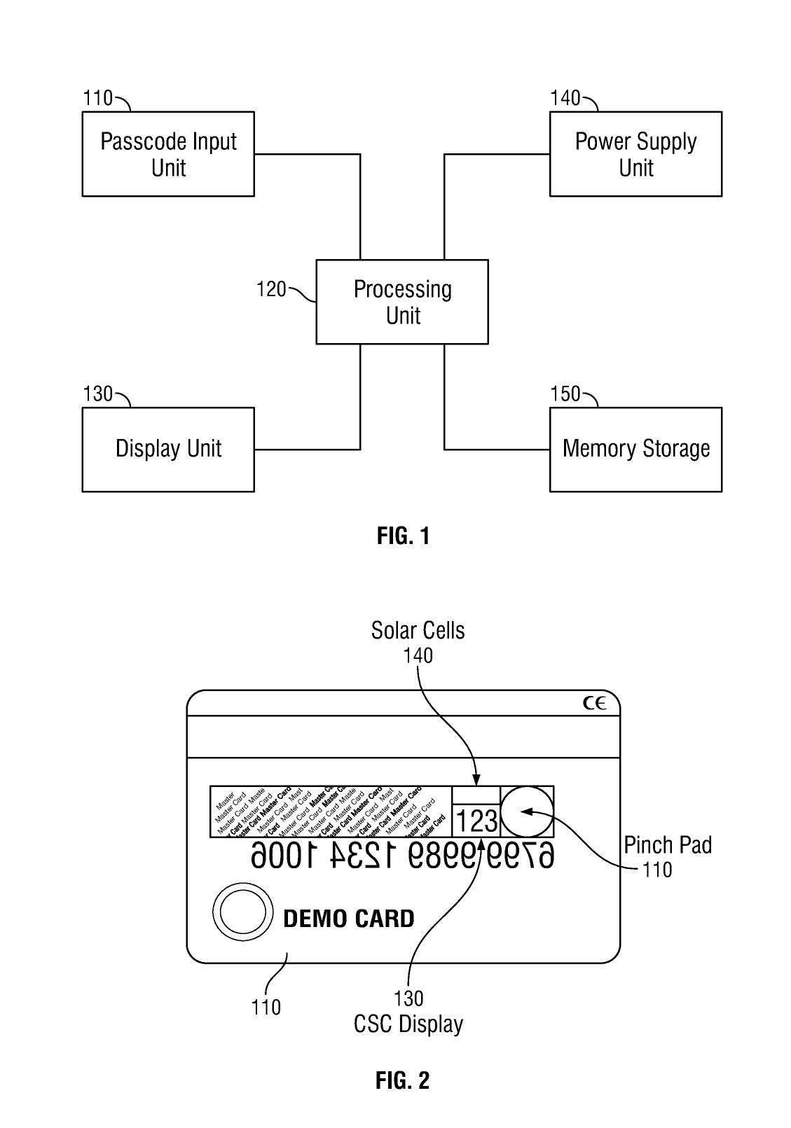

FIG. 1 shows a schematic block diagram of one example of a secure data card such as a credit card or debit card, for example. The secure data card 100 includes a passcode input unit 110, a processing unit 120, a display unit 130, a power supply unit (e.g., a battery or a solar cell) 140 and a memory storage unit 150. In some embodiments, the passcode input unit 110, display unit 130 and processing unit 120 are located on a base material and forms an integrated chip. In some embodiments, the power supply unit 140 is also located on the chip. In some embodiments, the power supply unit 140 is not located on the chip. FIG. 2 shows one example of a physical manifestation of a secure data card that may include some or all of the components shown in FIG. 1. In FIGS. 1 and 2 like elements are denoted by like reference numerals. In FIG. 2 the processing unit is not visible.

In some embodiments the passcode input unit 110 comprises a single pressure sensor or pressure sensor array. The pressure sensor or sensor array measures the pressure applied to it as a single point of contact without any spatial dimension. That is, in these embodiments the characteristics of the pressure that may be measured by the pressure sensor or sensor array includes two components: a magnitude component and a temporal component. The temporal component includes a duration over which the pressure is applied to the sensor or sensor array during a single contact event. The temporal component may also optionally include the start and stop time defining the time at which a single contact event with the sensor or sensor array begins and ends, respectively. As used herein, a “contact event” begins when continuous, uninterrupted pressure on the pressure sensor or sensor array is first applied and the contact event ends when pressure with the pressure sensor or sensor array terminates. Pressure is applied to the sensor or sensor array by making contact therewith. Contact with the sensor or sensor array may be achieved by the user's finger, a stylus or by other means.

In some embodiments only the magnitude component of the pressure is measured. In other embodiments only the temporal component of the pressure is measured. In yet other embodiments both the magnitude component and the temporal component are measured.

In some embodiments, a plurality of contact events is combined to form all or a portion of the passcode, including, for example, two or more contact events, three or more contact events, four or more contact events, five or more contact events, six or more contact events, seven or more contact events, eight or more contact events, nine or more contact events, ten or more contact events, 15 or more contact events, 30 or more contact events.

A pre-programmed passcode may be stored in the memory storage unit 150 of the data card prior to its issuance to a customer or other end user. For the user's convenience, in some implementations the pre-programmed passcode may be given to the user in symbolic form using, for example, alphanumeric or other characters. Each character may represent a magnitude component of a contact event, a temporal component of a contact event, or both a magnitude and temporal component of a contact event. The pre-programmed passcode is provided to the user along with the data card. In analogy to a PIN number associated with a debit card that is separately issued to the user, the pre-programmed passcode may be provided to the user separately (e.g., by mail or phone) from the data card.

In some embodiments, the passcode can be generated when the user uses the secure data card for the first time, for example, in a process similar to the process of setting up a passcode to a computer device such as a cellphone, a tablet, or computer: a user can be instructed to enter a passcode prior to using the secure data card for the first time. The passcode is then stored on the secure data card and used as an internal, pre-programmed passcode that must be replicated in order to authorize a transaction.

By way of illustration, the pre-programmed passcode may be represented by the alphanumeric string “abc123.” For simplicity, in this example the letters represent pressure magnitude components and the numbers represent temporal components. Turning first to the pressure magnitude component, the magnitude of the pressure applied to a sensor or sensor array may range from zero to some maximum, full scale pressure. This pressure range may be divided into a number of discrete portions, each of which is represented by a different letter. For instance, if the pressure magnitude range is divided into 3 portions, then one letter, e.g., “c,” may represent the maximum, full scale pressure magnitude, another letter, e.g., “b,” may represent ⅔^{rds} of the maximum pressure magnitude and yet another letter, e.g., “a,” may represent ⅓^{rd} of the maximum pressure magnitude.

Turning next to the temporal component of the passcode, if a sequence of numbers are used to represent the temporal component of a series of contact events in a passcode, each number in the sequence may represent the relative duration of a respective contact event. For example, in the passcode “abc123,” the numbers 123 may represent three contact events in which the second and third contacts events have durations that are respectively two and three times longer than the first contact event.

When the user first activates the data card, an initial calibration process may be performed during which the user enters the pre-programmed passcode with which he or she has been provided. The initial calibration process can begin, for example, by having the user press the sensor or sensor array as hard as she or she can, which, continuing with the example presented above, the processor in the data card can define as the letter “c.” The processor can then define ⅔^{rd} of the user's maximum pressure as the letter “b” and ⅓^{rd} of the user's maximum pressure as the letter “a.”

After entering the letters “abc” of the illustrative password “abc123,” the calibration process continues when the user enters the number “1” by initiating a contact event and mentally counting a time duration of one, which for convenience may be treated as one second, for example. At the end of the time duration of “1,” as mentally determined by the user him or herself, the user terminates the first contact event (by removing contact with the sensor or sensor array) and then begins another contact event to enter the number “2,” while mentally counting to two, at which point the second contact event terminates. Finally, the user performs a similar process to enter the number “3.”

The example presented above illustrates one advantage of the authorization technique described herein. Because each user will have his or her own technique for entering a contact event in terms of the pressure magnitude and/or time duration that is used to represent each alphanumeric or other character, two people can have the same symbolic passcode (e.g., abc123) and yet it will be treated as two different passcodes. That is, if one user has already calibrated a data card to recognize his or her passcode “abc123,” then if a second user enters the same passcode into the same data card, it is unlikely to be recognized as a valid match.

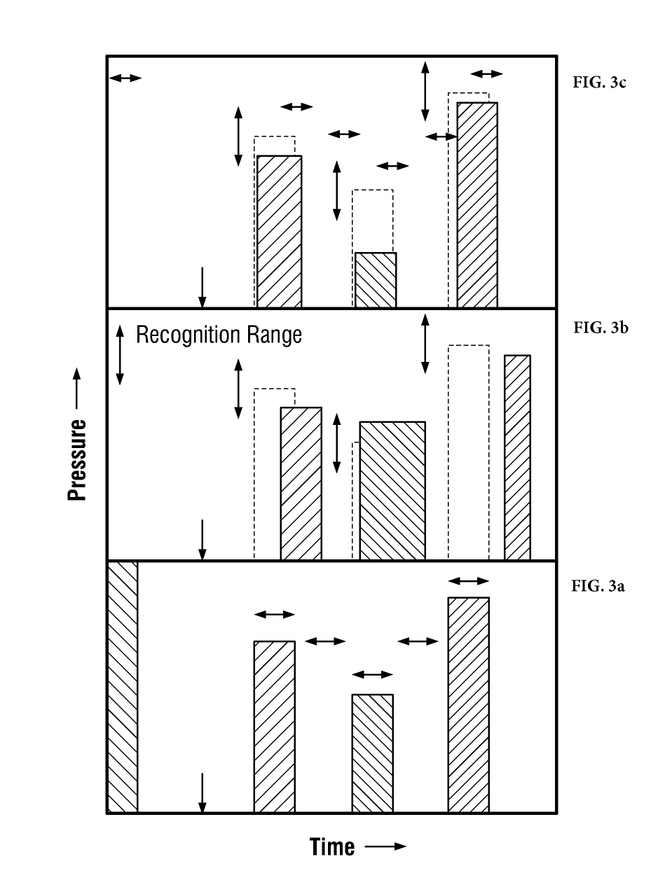

Another example will now be presented in which the passcode is a one-component passcode that has only a pressure magnitude component and not a temporal component. FIGS. 3a-3c are panels of the pressure versus time of a sequence of contact events applied to a pressure sensor or sensor array. FIG. 3a shows three contact events that represent a pre-programmed passcode that has already been calibrated by the user. The panels in FIGS. 3b and 3c each show the results of a user attempting to enter the passcode into the sensor or sensor array of the data card. The dashed lines shown in FIGS. 3b and 3c replicate the contact events of the pre-programmed passcode of FIG. 3a, whereas the shaded regions represent the actual contact events applied by the user when attempting to authorize a transaction or the like. Thus, the user will have entered the passcode with a perfect match if the shaded regions exactly overlap the regions enclosed by the dashed lines.

Turning first to the user's attempt to enter the passcode shown in FIG. 3b, it can be seen that the user's first contact event (from left to right) has a magnitude slightly less than the first contact event of the pre-programmed passcode. Likewise, the user's second contact event has a magnitude slightly more than the second contact event of the pre-programmed passcode and the user's third contact event has a magnitude slightly less than the third contact event of the pre-programmed passcode. Additionally, all three of the user's contact events begin at a later time in the sequence than the pre-programmed contact events. However, as stated above, in this example the passcode is using only the pressure magnitude component and not the temporal component. Thus, this delay in time of the user's contact events is ignored when determining if thepasscode entered by the user matches the pre-programmed passcode. It should be noted that while in this example the passcode does not use a temporal component, the number of contact events and the order in which they occur is taken into account in determining if a match is correct.

The vertically extending double-headed arrows shown in FIG. 3b each represent an allowed range of pressure values that will be accepted as matching the pre-programmed contact events represented by the dashed lines adjacent the double-headed arrows. As shown, all three of the user's contact events in FIG. 3b match the pre-programmed contact events of the pre-programmed passcode to within the allowed range. Accordingly, this user's attempted entry of the passcode will be treated as a match, despite the lack of a matching temporal component. Thus the user will be authorized to perform a transaction using the data card.

Turning now to the user's attempt to enter the passcode in FIG. 3c, it can be seen that the user's first and third contact events will be treated as matching the first and third pre-programmed contact events of the pre-programmed passcode. However, the user's second contact event will not be treated as matching the second pre-programmed contact event of the pre-programmed passcode because its pressure magnitude does not fall within the range specified by the double-headed arrows. Accordingly, the users attempted entry of the passcode will not be treated as a match in this case and the user will not be authorized to perform a transaction using the data card.

It should be noted that the range of pressure values that will be accepted as matching the pre-programmed contact events may be adjusted by the manufacturer or the card issuer or even in some cases by the user him or herself after first being authorized by entering a matching passcode. Of course, there will be a tradeoff between the degree of security offered by the passcode and the ease of correctly entering the passcode so that it correctly matches the pre-programmed passcode.

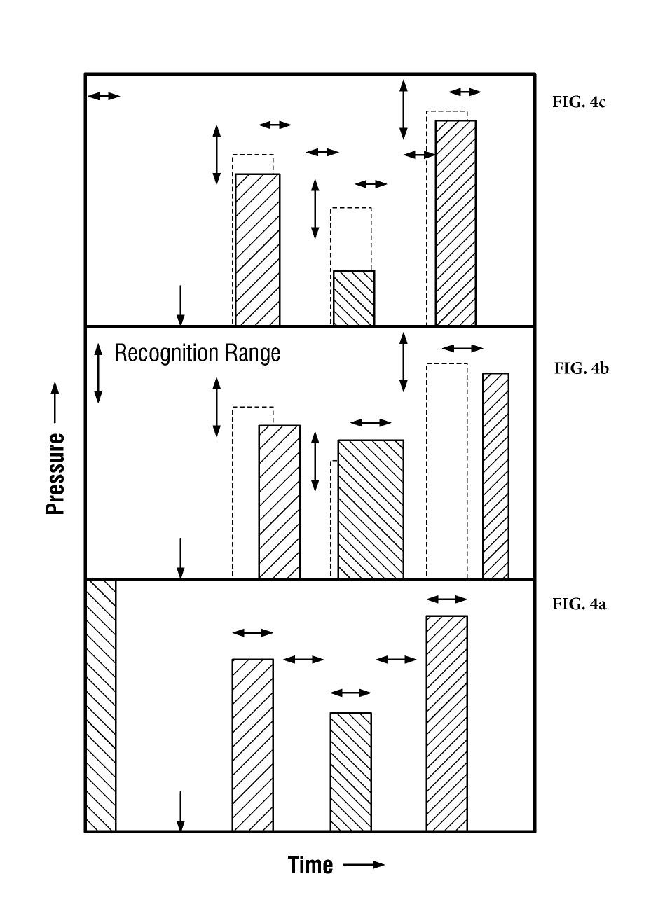

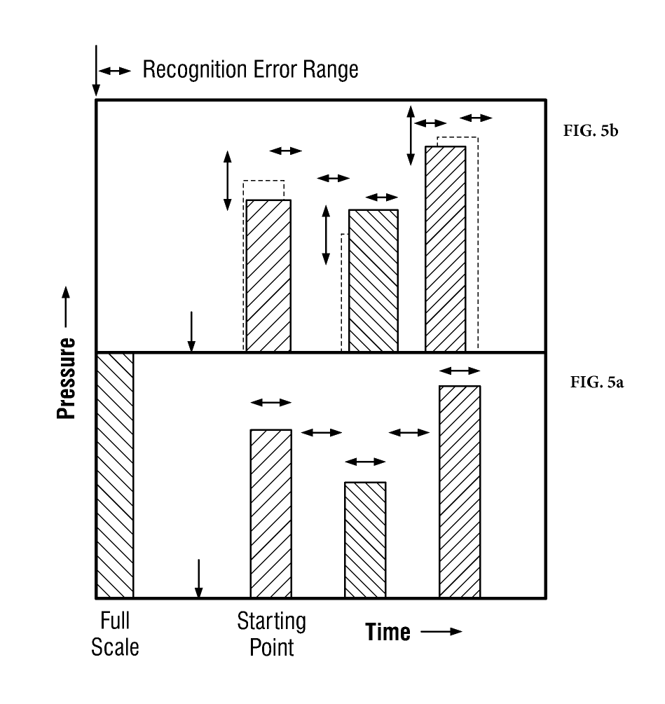

FIG. 4 shows another example in which the passcode has only a temporal component and not a pressure magnitude component. FIGS. 4a-4c are panels of the pressure versus time of a sequence of contact events applied to a pressure sensor or sensor array. FIG. 4a shows three contact events that represent a pre-programmed passcode that has already been calibrated by the user. The panels in FIGS. 4b and 4c each show the results of a user attempting to enter the passcode into the sensor or sensor array of the data card. The dashed lines shown in FIGS. 4b and 4c replicate the contact events of the pre-programmed passcode of FIG. 4a, whereas the shaded regions represent the actual contact events applied by the user. Thus, the user will have entered the passcode with a perfect match if the shaded regions exactly overlap the regions enclosed by the dashed lines.

Turning first to the user's attempt to enter the passcode shown in FIG. 4b, it can be seen that the pressure magnitude of all three of the user's contact events happen to match the pre-programmed contact events of the pre-programmed passcode to within the allowed range of pressure values, which is indicated by the vertically extending double-headed arrows. However, as mentioned above, in this example the pressure magnitude is being ignored for purposes of accessing whether the passcode entered by the user matches the pre-programmed passcode.

The horizontally extending double-headed arrows shown in FIGS. 4b and 4c each represent an allowed range of temporal values (the start and end times of a contact event) that will be accepted as matching the pre-programmed contact events. As shown in FIG. 4b only the temporal value of the second contact event matches the temporal valueof the corresponding contact event pre-programmed passcode. Thus, despite all three of the user's contact events having a pressure component that matches all three of the contact events of the pre-programmed passcode, the user's attempted entry of the passcode will not be treated as a match in the case of FIG. 4b and the user will not be authorized to perform a transaction using the data card.

On the other hand, FIG. 4c shows a situation in which the temporal components of all three of the user's contact events match all three temporal components of the corresponding pre-programmed contact events. However, the pressure magnitudes of only two (the first and third) of the user's contact events match the pressure magnitudes of the two corresponding pre-programmed contact events. In any case, since only the temporal component in this example is being considered, the user's attempted entry of the passcode will be treated as a match in the case of FIG. 4c and the user will be authorized to perform a transaction using the data card.

It should be noted that the range of temporal values that will be accepted as matching the pre-programmed contact events may be adjusted by the manufacturer or the card issuer or even in some cases by the user him or herself after first being authorized by entering a matching passcode. Of course, there will be a tradeoff between the degree of security offered by the passcode and the ease of correctly entering the passcode so that it correctly matches the pre-programmed passcode.

FIG. 5 shows yet another example in which the passcode has both a temporal component and a pressure magnitude component. FIG. 5a shows three contact events that represent a pre-programmed passcode that has already been calibrated by the user. The panel in FIG. 5b shows the results of a user attempting to enter the passcode into the sensor or sensor array of the data card. In this example both the pressure magnitude component and the temporal component of all three of the user's contact events match the corresponding contact events of the pre-programmed passcode. Accordingly, the user's attempted entry of the passcode will be treated as a match in the case of FIG. 5b and the user will be authorized to perform a transaction using the data card.

According to an embodiment, the pressure sensor or sensor array of the passcode input unit may include one or more transistor-based or capacitor-based sensors which are able to measure and digitize the pressure of contact events. In some embodiments the pressure sensor or sensor array can measure a continuous range of pressures. In other embodiments the pressure sensor or sensor array may only measure a plurality of discrete pressure values.

The pressure sensor or sensor arrays may include any suitable elements that are responsive to pressure, such as a piezoelectric material (e.g., BaTiO₃, Pb(ZrₓTi₁₋ₓ)O₃, lead zirconate titanate (PZT), ZnO, CdS, GaN), polymers (e.g., Polyvinylidene fluoride (PVDF), nylon, and poly(γ-benzyl-1-glutamate) (PBLG)), or nanowires of these materials, piezo conductive polymer composite nano materials (carbon nanotubes, nanowires, quantum tunneling composites), piezo resistive materials (e.g., Si thin film, Si nanowire, carbon nanotube, graphene, etc.). The pressure sensors may be also capacitive sensors having a flexible dielectric layer (e.g., nano/micro pyramids and rods structures). One exemplary flexible dielectric layer is described in a publication titled “Highly sensitive flexible pressure sensors with microstructured rubber dielectric layers” by Mannsfeld, S. C. B. et al., Nature Mater. 9,859-864 (2010), which is hereby incorporated by reference in its entirety.

The pressure sensors may also be electromagnetic sensors measuring the displacement of a diaphragm by means of changes in inductance or reluctance, Hall effect, or by Eddy current effect. The pressure sensors may also be optical sensors measuring the optical change (reflection, emission, absorption, fluorescence quenching, etc.) with applied pressure, for example, using Fiber Bragg gratings quantum dots emission. The pressure sensors may also be a micro-electrical-mechanical-system (MEMS) or a nano-electrical-mechanical-system (NEMS) device.

The pressure sensors may also be active matrix thin-film transistor (TFT) pressure sensors. The TFT pressure sensors may include a semiconductor thin film (e.g., Si, Ge, SiGe, III-V semiconductors, II-VI semiconductors, metal oxides, polymers, etc.) prepared by a suitable technique (e.g., evaporation, CVD, solution deposition) or a thin film including nanostructures of semiconductors (e.g., quantumdots, nanotubes, nanowires, etc.).

According to an embodiment, the pressure sensors comprise a transparent ZnO thin film. The ZnO thin film may function as conduction channel in a transistor and a pressure responsive material. An exemplary device including a ZnO thin film is described in a publication titled “Tactile Feedback Display with Spatial and Temporal Resolutions” by Siarhei Vishniakou, et al., Scientific Reports 3, Article number 2521 (2013 ), which is hereby incorporated by reference in its entirety.

The pressure sensor may be disposed on any suitable substrate (e.g.,glass, plastic). In some embodiments the substrate is substantially transparent. A transparent conductive layer such as indium tin oxide (ITO) or a thin layer of metal such as aluminum is disposed on the substrate. An electrically insulating layer (e.g., silicon nitride) may be disposed on the substrate to electrically insulate the transparent conductive layer, and serve as the dielectric of a capacitor between the ZnO filmand the transparent conductive layer. A layer of ZnO is disposed on the electrically insulating layer and is connected to an electrode (e.g., ITO). The ZnO layer preferably is encapsulated by a protective layer (e.g., aluminum oxide).

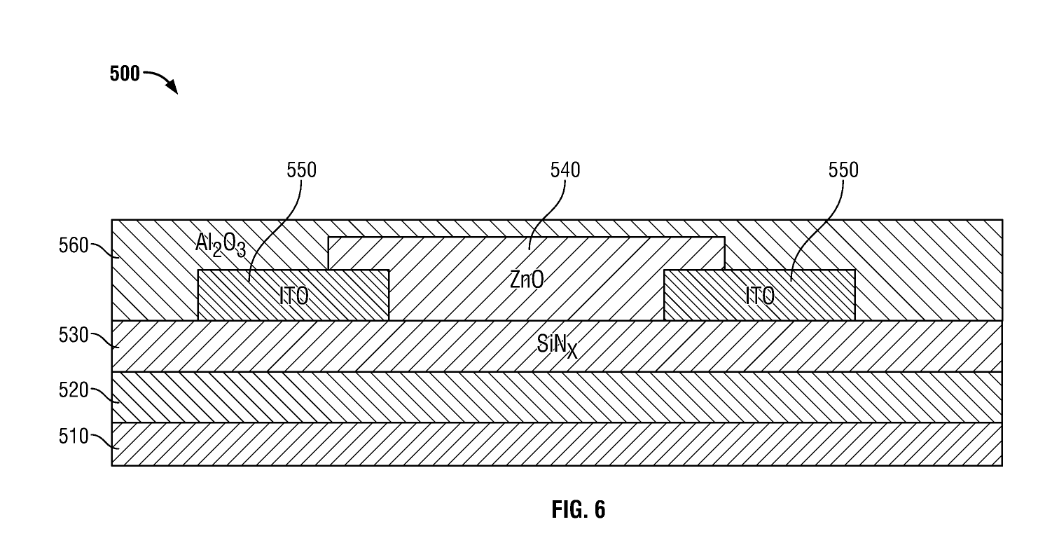

FIG. 6 schematically shows a cross section of such a pressure sensor 599. The pressure sensor may be disposed on any suitable substrate (e.g., glass, plastic) 510. Preferably, the substrate is substantially transparent. A transparent conductive layer 520 such as indium tin oxide (ITO) or a thin layer of metal such as aluminum is disposed on the substrate. An electrically insulating layer (e.g., silicon nitride) 530 may be disposed on the substrate to electrically insulate the transparent conductive layer, and serve as the dielectric of a capacitor between the ZnO film and the transparent conductive layer. A layer of ZnO 540 is disposed on the electrically insulating layer and is connected to an electrode (e.g., ITO) 550. The ZnO layer preferably is encapsulated by a protective layer (e.g., aluminum oxide) 560.

In some embodiments, authorization to conduct a transaction using the secure data card may require further proof in addition to the use of a passcode as described above. For instance, in some embodiments a biometric indicium may be employed, in which case in addition to authorizing the user to perform a transaction, the user's identity may be authenticated. Such a biometric indicium may include, by way of example, a fingerprint, an iris scan or a biochemical specimen from the user. The biochemical specimen may include, by way of example, body odor or breath or bodyfluids such as saliva or tears. In some embodiments two or more biometric indicia may be employed.

If a biometric indicium is to be employed, the secure data card may include an input unit to collect the biometric indicium or a measurement thereof (e.g., at the time of transaction). This input unit may be incorporated with or separate from the passcode input unit. For example, if the biometric indicium is based on body odor or breath, the input unit may include an electronic nose.

In some embodiments, entry of a correctly matching passcode directly results in authorization. In other embodiments the user is prompted to enter a two-component passcode (e.g., a passcode having both a pressure magnitude and a temporal component) to retrieve a one-component passcode (e.g., a passcode having either a pressure magnitude or a temporal component). In particular, a passcode that requires both a pressure magnitude component and temporal component may be converted, before authentication, into a passcode that only requires a pressure magnitude component or a temporal component. In such embodiments, a passcode requiring two components entered at the time of transaction is compared with the internal pre-programmed passcode that has two components. If the two-component passcode entered at the time of transaction matches the stored, two-component passcode, a new one-component passcode can be generated by the internal processor and displayed on the display unit. The user may use this one-component passcode to conduct subsequent transactions. In some case the number of subsequent transactions that may be performed, or the length of time over which subsequent transactions may be performed, may limited to some specified quantity, after which the user will be required to once again enter the two-component passcode.

In some embodiments, the display unit is used as a timing device to ensure consistency and accuracy of passcode input. For example, while a user is applying pressure to the pressure sensor or sensor array, the display unit can function as a timer to help the user to apply pressure for a consistent length of time. The display may also allow the user to precisely control the time interval between consecutive contact events.

In some embodiments, when the authorization process is completed, the transaction can be either authorized or denied. Upon authorization, the secure data card allows a payment transaction or grants access to restricted information. For example, the secure data card can function as a secure FOB that displays a dynamically varied card security code through which a user can access restricted data, which may include, but is not limited to, medical records or a secure company website. In some embodiments, after the transaction is authorized, the secure data card may send a radio frequency (RF) signal to a card reader or unlock a magnetic strip to allow a user access to a restricted location.

In some embodiments, the display can be used as part of the card activation process. For example, upon authorization, the display unit may show one or more of the following data: the card holder's name or a portion of the name, the card number or portion of the card number, a CSC number and the expiration date of the secure data card.

In the embodiments described above, the pressure sensor or sensor array that receives a one or two component passcode is provided on a secure data card to authorize a transaction or the like. In other embodiments, however, the pressure sensor or sensor array and the associated techniques described above may be employed on a wide variety of devices other than a secure data card. For example, a portable electronic device (e.g., a phone, a tablet, a laptop computer, a medical device) or a non-portable device (e.g., an automatic teller machine (ATM), a security system) may include a pressure sensor or sensor array as described above. By successfully entering a passcode into the pressure sensor or sensor array of such a device, the user may be provided access to some or all of the functionality offered by the device.

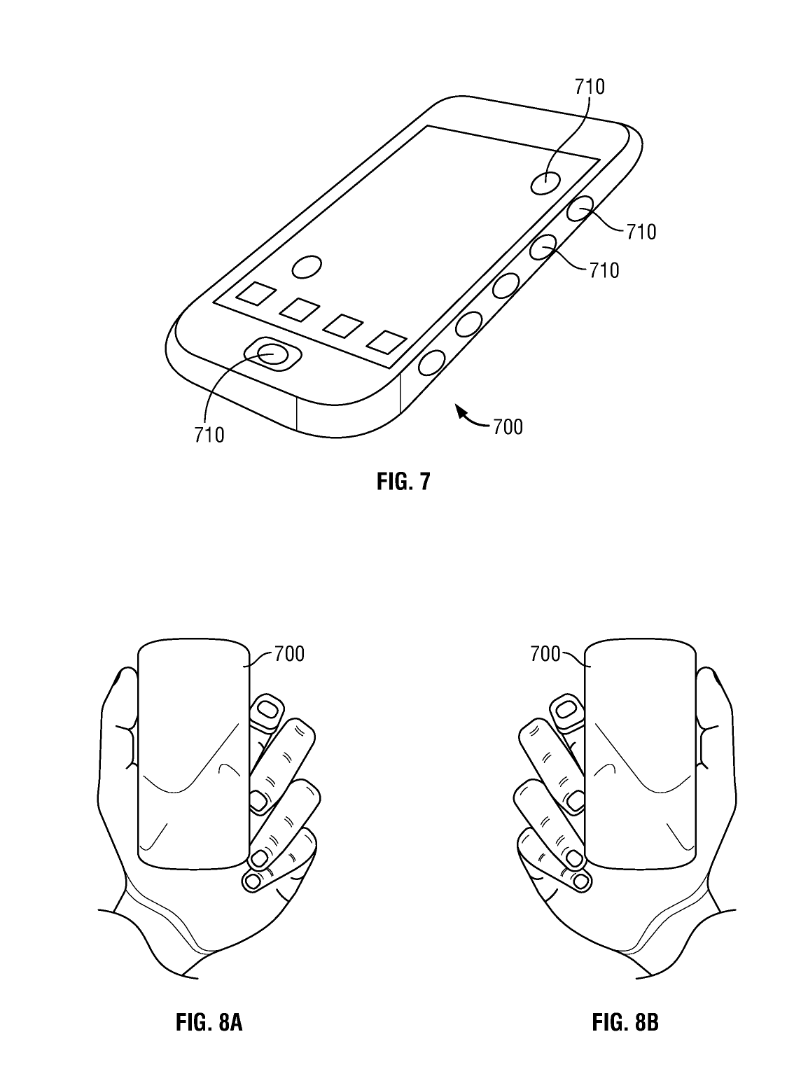

One example of a device on which a pressure sensor or sensor array may be disposed is shown in FIG. 7. In this example the device 700 is a mobile phone. The mobile phone 700 may include a single sensor or sensor array or, as shown in FIG. 7, two or more sensors or sensor arrays 710 on which pressure may be applied to measure the magnitude and/or the temporal duration of applied pressure. As further shown in FIG. 7, the sensors or sensor arrays 710 may be located on one or more surfaces of the mobile phone 700. As shown in FIGS. 8a and 8b, if multiple sensors or sensor arrays 710 are employed, they may be distributed over the mobile phone 700 in a symmetric manner so that it may be held in either the user's left hand or right hand.

In the embodiments described above, a passcode is used to authorize a transaction, provide access to an event or location, or to make the functionalityof device available to the user. In other embodiments, however, the passcode may be used solely to authenticate the user. In yet other embodiments the passcode may be used to both authenticate and authorize the user. Such embodiments may be useful, for example, with applications that require a higher degree of security. For example, a pressure sensor or sensor array may be provided on an automobile or a firearm, in which case the user must successfully enter a passcode into the pressure sensor or sensor array in order to access the functionality of the weapon.

According to an embodiment, the processor 120 shown in FIG. 1 may comprise one or more general purpose computers programmed with one or more software applications that enable the various features and functions of the embodiments disclosed herein. Those of ordinary skill in the art will recognize that memory storage 150 shown in FIG. 1 may comprise non-transitory physical computer memory, one or more non-transitory physical storage devices and/or other components. The memory storage 150 may comprise random access memory (RAM), read only memory (ROM), or other memory. The memory storage 150 may store computer-executable instructions to be executed by one or more processors as well as data which may be manipulated by the one or more processors. Physical storage devices may comprise floppy disks, hard disks, optical disks, tapes, or other storage devices for storing computer-executable instructions and/or data. One or more software applications may be loaded into the memory and run on an operating system of the computer. In some implementations, an Application Program Interface (API) may be provided to, for example, enable third-party developers to create complimentary applications, and/or to enable content exchange.

The processor 120 may also comprise one or more digital signal processors (DSPs), application specific integrated circuits (ASICs), field programmable gate arrays (FPGAs), discrete logic, or any combinations thereof. When the various features and functions described above are implemented partially in software, a device may store instructions for the software in a suitable, non-transitory computer-readable storage medium and may execute the instructions in hardware using one or more processors to perform the techniques of this disclosure.

As mentioned above, aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

In relation to the claims, it is intended that when words such as “a,” “an,” “at least one,” or “at least one portion” are used to preface a feature there is no intention to limit the claim to only one such feature unless specifically stated to the contrary in the claim.

The descriptions above are intended to be illustrative, not limiting. Thus, it will be apparent to one skilled in the art that modifications may be made without departing from the scope of the claims set out below.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

What is claimed is:

1. A method of authorizing a transaction or access based on a secure data card, comprising:
receiving a passcode from a user, the passcode including a magnitude and/or a temporal duration of pressure applied by the user to a pressure sensor or pressure sensor array disposed on the secure data card;
comparing the passcode with an internal passcode associated with the secure data card, wherein the internal passcode is not visibly shown on the secure data card; and
authorizing the transaction or access if the passcode matches the internal passcode or denying the transaction or access if the passcode does not match the internal passcode.

2. The method of claim 1, wherein the passcode is a one-component passcode that includes either a pressure magnitude component or a temporal component but not both a pressure magnitude component and a temporal component.

3. The method of claim 2 wherein authorizing the transaction if the passcode matches the internal passcode includes authorizing the transaction or access if the one-component of the passcode matches the one-component of the internal passcode by less than a predetermined amount.

4. The method of claim 1,wherein the passcode is a two-component passcode that includes both a pressure magnitude component and a temporal component.

5. The method of claim 4 wherein authorizing the transaction if the passcode matches the internal passcode includes authorizing the transaction or access if the two-components of the passcode respectively match the two-components of the internal passcode by less than predetermined amounts.

6. The method of claim 2 wherein the passcode includes a plurality of user contact events each representing a distinct application of pressure applied to the pressure sensor or sensor array, each contact event being separated in time from one another such that contact applied by the user to the pressure sensor or sensor array is removed between the contact events.

7. The method of claim 4 wherein the passcode includes a plurality of user contact events each representing a distinct application of pressure applied to the pressure sensor or sensor array, each contact event being separated in time from one another such that contact applied by the user to the pressure sensor or sensor array is removed between the contact events.

8. The method of claim 6 wherein the one-component passcode includes a first component selected from the group consisting of a pressure magnitude component and a temporal component and further comprising authorizing the transaction or access if the first component of each of the user contact events matches the first component of each of a corresponding contact event of the internal passcode.

9. The method of claim 8 wherein the transaction is authorized regardless of whether a second component of the user contact events of the passcode matches a second component of each of the corresponding contact events of the internal passcode, the second component being the other of the pressure magnitude component and the temporal component that is not selected as the first component.

10. The method of claim 7 wherein the two-component passcode matches the internal passcode if the pressure magnitude component and the temporal component of each of the user contact events matches the pressure magnitude component and the temporal component of each of a corresponding contact event of the internal passcode.

11. The method of claim 7 wherein the two-component passcode matches the internal passcode if the pressure magnitude component and the temporal component of each of the user contact events matches, in a same sequential order, the pressure magnitude component and the temporal component of each of a corresponding contact event of the internal passcode.

12. The method of claim 1, wherein the authorizing results in display of card information selected from the group consisting of cardholder's name or a part thereof, card number or a portion thereof, a Card Security Code, card expiration date, and a combination thereof.

13. The method of claim 1, wherein the authorizing results in activation of the card by radio frequency (RF) signals.

14. The method of claim 1, wherein authorizing step results in activation of a magnetic strip within the secure data card.

15. The method of claim 1, wherein a number of consecutive denials of the transaction or access is counted and further comprising deactivating the secure data card when the number of consecutive rejections reaches a pre-determined number.

16. The method of claim 1, wherein the authorizing is conducted either locally on the secure data card, or remotely at a centralized server.

17. The method of claim 1, further comprising:
receiving at least one biometric indicium from the user;
comparing data extracted from the at least one biometric indicium with data representing a pre-stored biometric indicium associated with the user; and
authorizing the transaction or access only if the passcode matches the internal passcode and the data extracted from the at least one biometric indicum matches the data representing the pre-stored biometric indicium associated with the user.

18. The method of claim 18, wherein the biometric indicium comprises at least one biometric indicium selected from the group consisting of a fingerprint, an iris scan, and a biochemical specimen from the body.

19. The method of claim 18, wherein the biochemical specimen from the body comprises one selected from the group consisting of DNA in body fluid and characteristic molecules from breath.

20. The method of claim 19, wherein the DNA in body fluid or characteristic molecules from breath are detected by one or more sensors.

21. The method of claim 20, wherein the sensors are arrays of chemical, biological, or biochemical sensors.

22. A secure data card, comprising:
a passcode input unit that includes a pressure sensor or sensor array, the passcode input unit being configured to receive a passcode that includes a magnitude and/or a temporal duration of pressure applied by a user to the pressure sensor or pressure sensor array;
a display unit;
a power unit;
a memory unit; and
a processor that is configured to (1) compare the received passcode with an internal passcode stored in the memory unit, wherein the internal passcode is not visibly shown on the secure data card and (2) authorize a transaction or access if the passcode matches the internal passcode or denying the transaction or access if the passcode does not match the internal passcode.

23. The secure data card of claim 22, wherein the processor comprises one or more CMOS chips.

24. The secure data card of claim 22, wherein the display unit includes a LCD or LED screen.

25. A method of authorizing a user to access functionality provided by an electronic device, comprising:
receiving a passcode from a user, the passcode including a magnitude and/or a temporal duration of pressure of a single point of contact applied by the user to a pressure sensor or pressure sensor array disposed on the electronic device;
comparing the passcode with an internal passcode associated with the device, wherein the internal passcode is not visibly shown on the electronic device; and
allowing the use to access the functionality provided by the electronic device if the passcode matches the internal passcode or denying access to the functionality if the passcode does not match the internal passcode.

26. The method of claim 25, wherein the passcode is a one-component passcode that includes either a pressure magnitude component or a temporal component but not both a pressure magnitude component and a temporal component.

27. The method of claim 26 wherein allowing the user to access the functionality if the passcode matches the internal passcode includes allowing the user to access the functionality if the one-component of the passcode matches the one-component of the internal passcode by less than a predetermined amount.

28. The method of claim 25, wherein the passcode is a two-component passcode that includes both a pressure magnitude component and a temporal component.

29. The method of claim 28 wherein allowing the user to access the functionality if the passcode matches the internal passcode includes allowing the user to access the functionality if the two-components of the passcode respectively match the two-components of the internal passcode by less than predetermined amounts.

30. The method of claim 26 wherein the passcode includes a plurality of user contact events each representing a distinct application of pressure applied to the pressure sensor or sensor array, each contact event being separated in time from one another such that contact applied by the user to the pressure sensor or sensor array is removed between the contact events.

31. The method of claim 28 wherein the passcode includes a plurality of user contact events each representing a distinct application of pressure applied to the pressure sensor or sensor array, each contact event being separated in time from one another such that contact applied by the user to the pressure sensor or sensor array is removed between the contact events.

32. The method of claim 30 wherein the one-component passcode includes a first component selected from the group consisting of a pressure magnitude component and a temporal component and further comprising allowing the user to access the functionality if the first component of each of the user contact events matches the first component of each of a corresponding contact event of the internal passcode.

33. The method of claim 32 further comprising allowing the user to access the functionality regardless of whether a second component of the user contact events of the passcode matches a second component of each of the corresponding contact events of the internal passcode, the second component being the other of the pressure magnitude component and the temporal component that is not selected as the first component.

34. The method of claim 31 wherein the two-component passcode matches the internal passcode if the pressure magnitude component and the temporal component of each of the user contact events matches the pressure magnitude component and the temporal component of each of a corresponding contact event of the internal passcode.

35. The method of claim 31 wherein the two-component passcode matches the internal passcode if the pressure magnitude component and the temporal component of each of the user contact events matches, in a same sequential order, the pressure magnitude component and the temporal component of each of a corresponding contact event of the internal passcode.

36. The method of claim 25 wherein the electronic device is a mobile phone.
